(19) United States
(12) Patent Application Publication
(10) Pub. No.: US 2013/0123021 A1
(43) Pub. Date: May 16, 2013

(54) GAMER GROUPING AND SELECTION SYSTEMS AND METHODS

(71) Applicant: Gamerconnect LLC, Warren, NJ (US)

(72) Inventors: Andrew Stubb, Millington, NJ (US); Christopher Thomas Pike, Raleigh, NC (US); Jacob Kogan, Lanham, MD (US); Thomas Herbert Pike, Raleigh, NC (US)

(73) Assignee: GAMERCONNECT LLC, Warren, NJ (US)

(21) Appl. No.: 13/676,001

(22) Filed: Nov. 13, 2012

Related U.S. Application Data
(60) Provisional application No. 61/559,320, filed on Nov. 14, 2011.

(51) Int. Cl. G07F 17/32

(52) U.S. Cl. CPC G07F 17/3227
USPC 463/42

(57) ABSTRACT

Gamer grouping and selection systems and methods are disclosed. According to an aspect, a method includes receiving data associated with a plurality of gamers. The method also includes analyzing the data to assign each of the gamers to one of multiple gamer groups. Further, the method includes providing a search tool to at least one gamer for searching for other gamers including on the assigned groups.

### CROSS REFERENCE TO RELATED APPLICATION

This application claims the benefit of U.S. Provisional Patent Application No. 61/559,320, filed Nov. 14, 2011, the disclosure of which is incorporated herein by reference in its entirety.

### TECHNICAL FIELD

The presently disclosed subject matter relates to social networking. More particularly, the presently disclosed subject matter relates to gamer grouping and selection systems and methods.

### BACKGROUND

It is estimated that approximately 72% of American households play computer or computer games, and millions more play around the world. In opposition to many commonly held views, recent scientific studies are indicating that multiplayer games increase social skills in the real world. Computer-based or Internet games have become an increasingly social experience that for many is as rich and important as any other interaction they undertake in their daily lives. Lessons from the engagement surrounding these games are being implemented in new educational approaches. In addition, with the advent of “casual” multiplayer gaming, participation globally is increasing rapidly.

Unfortunately, the way that gamers find each other either socially or to play together has not kept pace with the complex and diverse gaming environment. For example, there exists no recourse for a person who only wants to play, for example, a popular mobile game with people who share their behaviors and views around gaming. Other gamers may wish to play with the same people across different gaming platforms without sharing their real life identity. Further, many gamers do not want to post their preferences for gaming on existing social networking tools. If the current systems for matching gamers use any criteria at all, they do so based solely on their users' respective in-game results, and sometimes another user's feedback, which may in fact be misleading in terms of a gamer's overall skill, behaviors or interests.

Efforts have been made to match gamers. However, existing techniques match gamers for playing games, rather than providing a gamer with tools to search for other gamers. Additionally, these techniques are typically specified within computer games and or within the environment of a computer gaming platform, usually contemplating the next session or game. Accordingly, for at least these reasons, it is desired to provide improved techniques for connecting gamers with one another for social interaction and for the purpose of game play.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are gamer grouping and selection systems and methods. According to an aspect, a method includes receiving data associated with a plurality of gamers. The method also includes analyzing the data to assign each of the gamers to one of multiple gamer groups. Further, the method includes providing a search tool to at least one gamer for searching for other gamers based on the assigned groups.

According to another aspect, a method includes collecting information about a gamer/user over a network and into a database. The method also includes organizing the information using approaches including a sophisticated mathematical algorithm for grouping users. Further, the method includes allowing a flexible search process including computer assistance. The method also includes allowing searching gamers to view each other's information, communicate and peer with other gamers for social or gaming purposes.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 illustrates a block diagram of an example system for grouping gamers in accordance with embodiments of the present subject matter;

FIG. 2 illustrates a flow chart of an example method of a gamer grouping and matching technique in accordance with embodiments of the present subject matter;

FIG. 3 illustrates a flow chart of an example method for collecting different types of information from gamers in accordance with embodiments of the present disclosure;

FIG. 4 illustrates a flow chart of an example method of appending additional information to a gamers profile using a mathematical algorithm in accordance with embodiments of the present disclosure;

FIG. 5 illustrates a flow chart of an example method of the gamer selection feature incorporating searching for gamers and matching gamers in accordance with embodiments of the present subject matter;

FIG. 6 illustrates a flow chart of an example method of the gamer selection feature portraying search results in accordance with embodiments of the present subject matter;

FIGS. 7-15 depict various screen shots presented to a gamer in accordance with embodiments of the present disclosure;

FIG. 16 illustrates a flow chart of an example method of PDDP k-means program flow in accordance with embodiments of the present disclosure;

FIG. 17 illustrates a flow chart of an example method of size program flow in accordance with embodiments of the present disclosure; and

FIGS. 18 and 19 depict block diagrams of an example overall architecture of software programs in accordance with embodiments of the present disclosure.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Computer and Internet gaming players have historically been matched within games and specifically to play future gaming sessions. Disclosed herein are system and method embodiments for collecting and storing information about game players, organizing gamers into discrete groups based on their psychographic and game-related information, and allowing gamers to search for and find other gamers with whom they would like to game and or develop a social relationship separate from any game, particular gaming environment or gaming sessions. For example, systems and methods disclosed herein may use mathematical algorithms along with proprietary inputs to group users. Systems and methods disclosed herein may aid gamers in the searching of groups and psychographic characteristics of other gamers. Users are offered a superior experience through this method and apparatus. Systems and methods disclosed herein provide users with the ability to store information about themselves in a database and view that information, as well as information about other users, in a graphical user interface-implemented profile page and privacy approach. Users are given the ability to manage relationships and communicate with each other to determine gaming compatibility by use of the systems and methods disclosed herein.

Embodiments of the present subject matter provide systems and methods for gamer grouping and matchmaking through gamers searching for other gamers. Systems disclosed herein may utilize user inputted information, quantification of that information, and use of mathematical tools such as clustering, self-described user and game behavior to provide more nuanced and appropriate searching for other gamers. The selection of gaming partners, whether for gaming or social purposes, may be left to the gamers with computer assistance. The gamers may subsequently communicate, self-determine if they should become gaming peers, later playing with each other or getting to know each other. Also, the presently disclosed systems may be accessed outside of a particular gaming platform or environment for providing unprecedented freedom for users to find matches that are appropriate to their desires. For example, in one or more embodiments, a user can find matches for a console game on their mobile device, tablet device, personal computer, or the like.

In accordance with embodiments of the presently disclosed subject matter, gamer grouping and matching techniques are provided, which may be embodied in various forms such as methods, systems, products of processes, configured storage media, computer data structures and the like. Unless otherwise stated, one form of embodiment does not necessarily limit other forms of embodiment. For instance, discussion of methods herein may illustrate systems of the present subject matter, which may include computers configured to operate according to the methods, without necessarily requiring that the systems include every limitation discussed in connection with the methods. Likewise, the discussion of systems may illustrate methods without necessarily limiting the methods, and so on, for each form of the embodiment disclosed herein.

Reference is made herein to exemplary embodiments, and specific language will be used herein to describe the same. But alterations and further modifications of the features illustrated herein, and additional applications of the principles of the embodiments illustrated herein, which would occur to one skilled in the relevant art(s) and having possession of this disclosure, should be considered within the scope of the presently disclosed subject matter.

In describing the present subject matter, the meaning of important terms is clarified, so the claims must be read with careful attention to these clarifications. Specific examples of are given to illustrate aspects of the present subject matter, but those of skills in the relevant art(s) will understand that other examples may also fall within the meaning of the terms used, and within the scope of one or more claims.

As referred to herein, the term “gamer” may refer to a user or individual who plays games, such as computer games for entertainment and achievement. For example, games may be referred to as Internet or computer-based games. Systems and methods disclosed herein may be applied to multiplayer games, including card games, board games and sporting games, such as golf. At times the term “user” may be used interchangeably with gamer. The present document sometimes refers to gamers who are searching for others, or searching gamers. In other areas, the present document may refer to gamers who are matched to the search criteria. The term “gaming” is used within the present document to refer to the act of play computer-based or Internet-based games on various platforms, including computers, consoles, tablets, phones, or the like.

As referred to herein, the terms “cluster” and “groups,” or derivations of those words, are used through the document. The terms cluster or clustering are sometimes used in the mathematical sense. Clustering is a mathematical technique that may be used to group various things together. While not described here in detail herein, systems and methods described herein may be used to reduce gamer information to, for example, vectors (in mathematics, vectors in a finite dimensional Euclidean space). The idea of clustering may be traced back to the 1956 work of Steinhaus (H. Steinhaus. Sur la division des materiels en parties. Bulletin de l'Academie Polanaise Des Sciences Class III Mathematique, Astronomie, Physique, Chimie, Geologie et Geographie, 4(12):801-804, 1956), the disclosure of which is incorporated herein in its entirety. Gamers may subsequently be grouped into clusters based on the distance between the centroids of those vectors. The weighting of information used for clustering, as well as the number of clusters may be adjusted based on the knowledge and experience of the administrators. The terms groups and clusters, as well as the terms grouping and clustering, may be used interchangeably throughout the present document.

As referred to herein, the term “psychographic” and its derivations are used within the present document. The term psychographic should be understood by those of skill in the art. In this document, the psychographic refers to various attitudes, values, interests, opinions, and the like that are valuable to match gamers together. This term is a broader and different than skill, gaming personality, and the like. Psychographics may be targeted toward games that are played for social, entertainment, or achievement reasons.

Gamer grouping and matching techniques in accordance with embodiments of the present subject matter may allow gamers to find others with shared skills, traits and interests using a computer system. Users may enter profile information and find compatible people. Further, gamer grouping and matching techniques disclosed herein are based on gaming psychographics and game-specific information. Also, the information may be used for grouping and matching across various games and platforms. Skill levels and other data may be collected both from users and directly from the games by computer. A gamer's true identity may be kept private. A user's name and/or gender may be kept private. Also, gamer grouping and matching techniques may use clustering techniques described herein to identify similar gamers. By use of these techniques, unique profiles, search results presentations, and communication approaches between gamers may be provided.

In accordance with embodiments, information on computer media may be captured by direct user entry or through other computers systems. Such information about a particular gamer is referred to as a “gamer profile.” Profile may refer to a repository of information about people. As referred to herein, gamer profile includes general, psychographic and game-specific information that has been collected from users or gamers. The gamer profile may subsequently be enhanced through techniques described herein and computer systems that use various mathematical techniques along with proprietary values for certain input parameters and proprietary methods. The input formats may be in accordance with any suitable mathematical technique. However, different values may be given to input parameters based on experience with the gamer grouping and matching techniques disclosed herein. The outputs of these computer programs may be suitably reviewed and adjusted. In particular, the mathematical techniques may add information regarding gamers who are similar in certain desirable ways. The profile may be updated with this information.

In one or more embodiments, an interested gamer may subsequently search for other gamers who share their skills, interests and psychographics, as well as for a specific criterion. Gamers may also have the ability to search for gamers whose profiles are dissimilar to theirs according to one or more criteria. Gamers whose information is being searched may be protected through a privacy method within the computer system. Gamers may initiate their own manual searches, or may use the computer system's suggested searches to search for similar gamers. The search results may portray information about the profile, including a method that shows the percentage overlap in their profiles.

A gamer who has initiated the search can then contact other gamers through secured communications methods. The gamer that was found will be shown some profile information of the searching gamer. The found gamer may then communicate back to the searching gamer. The searching gamer, and the found gamer, may designate each other as “peers” and share more profile information. A gamer can group and track various information about friends for future use and reference.

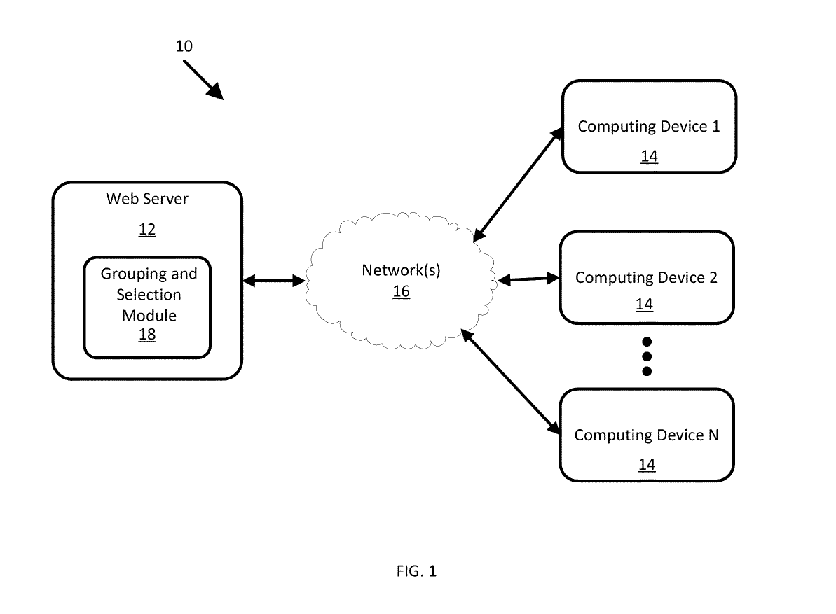

FIG. 1 illustrates a block diagram of an example system 10 for grouping gamers in accordance with embodiments of the present subject matter. Referring to FIG. 1, the system 10 may include a web server 12 and one or more computing devices 14 configured to communicate with each other via one or more networks 16. The web server 12 and computing devices 14 may each include at least one processor and memory configured for implementing methods, either partially or entirely in accordance with embodiments of the present subject matter. The network(s) 16 may be the Internet, any suitable wired or wireless network, a mobile network, the like, or combinations thereof. In this example, the network(s) 16 is the Internet, and users of computing devices 14 may communicate with the web server 12 via the Internet to access a website managed by the web server 12 for grouping gamers in accordance with embodiments disclosed herein. Further, in this example, the computing devices 14 may each be a gaming console, a desktop computer, a laptop computer, a tablet computer, or any suitable computing devices configured to provide a gaming interface for a user to play a video game either residing on the computing device itself or a remote computing device.

The web server 12 may include a grouping and selection module 18 configured to implement a method for grouping gamers. The module 18 may be implemented by a processor and memory of the web server 12. For example, the module 18 may be implemented with hardware, software, firmware, or combinations thereof. In an example method, the module 18 may receive data associated with multiple gamers, such as the users of the computing devices 14. The data may be received via the network(s) 16. The data may include, but is not limited to, psychographic and game-related information of the gamers. Further, the module 18 may analyze the data to assign each of the gamers to a gamer group, which may be one of multiple different gamer groups. Gamers may be assigned to a gamer group based on whether they are determined to be compatible with each other for gaming. This determination may be made based on, for example, but not limited to, a gamer profile. Further, the module 18 may provide a search tool to one or more of the gamers for searching for other gamers based on the assigned groups. The search tool may be implemented on one of the computing devices 14 for use by a user of the device to search within one or more of the gamer groups.

In accordance with embodiments, analysis of data to assign gamers to a gamer group may include applying a mathematical algorithm to the data for assigning each of the gamers to one of the gamer groups. Application of the mathematical algorithm may include clustering each gamer into one of the gamer groups. The search tool may define search criteria based on one or more of general information, action gaming psychographics, casual gaming psychographics, and game specific information. Further, the search tool may be configured to be used to identify one or more gamers based on a search criteria specified by the gamers. Subsequent to being grouped, the gamers grouped together may communicate with one another. The web server may manage interaction with and information associated with other identifier garners, or garners assigned to the same group.

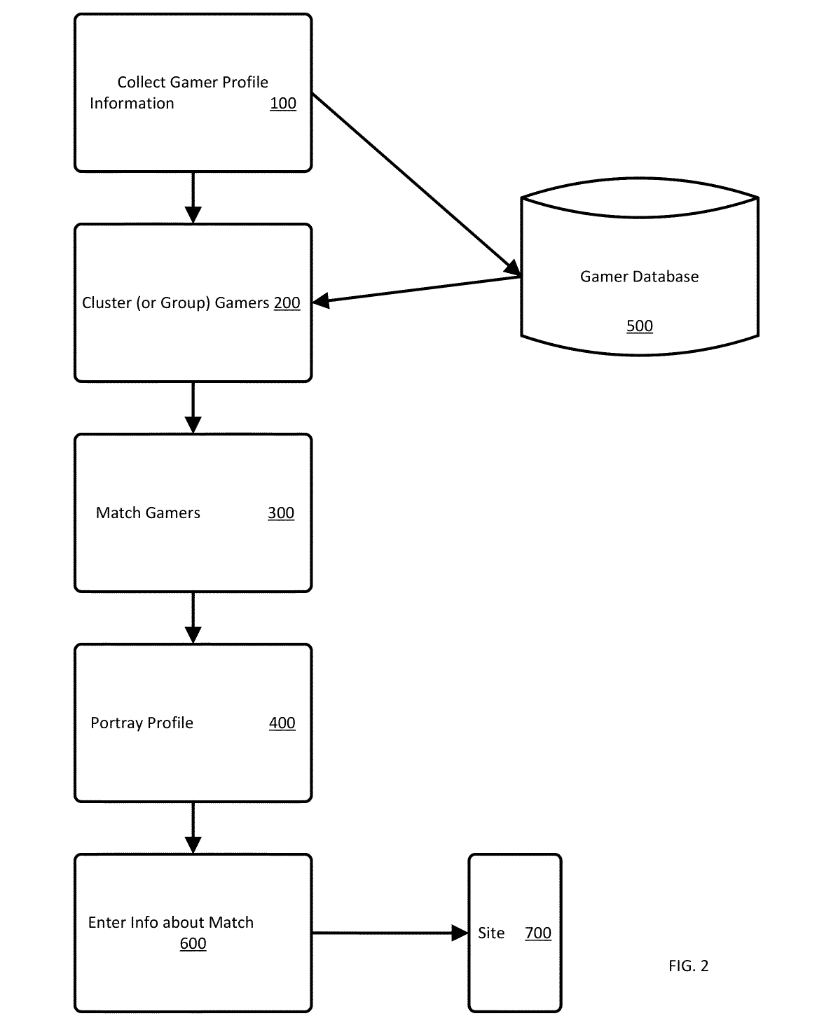

FIG. 2 illustrates a flow chart of an example method of a gamer grouping and matching technique in accordance with embodiments of the present subject matter. The method may be implemented, for example, by the module 18 of the web server 12 shown in FIG. 1. Referring to FIG. 2, the method may include collecting profile information from garners using various computing devices (step 100). For example, profile information may be received from the computing devices 14 shown in FIG. 1. The gamer profile information may be stored in a gamer database 500 that is stored on a computer data drive of any suitable type. For example, the profile information may be stored in memory accessible by the web server 12.

Subsequently, at step 200, the method includes processing the gamer information using mathematical algorithms, such as clustering, on a computer processor. In an example, garners may be clustered (or grouped) together and labeled based on information contained in their profiles. This information may be updated to the gamer database 500.

The method includes matching garners (step 300). For example, a combination of the profile information entered in a database by a gamer and the clustering algorithm output may be used to match garners together. Further, for example, a gamer may enter criteria into a computer input device. These criteria may be used by the computer processor to search the gamer database 500.

Subsequently, the search may return information about garners who match their criteria. The method may include portraying or presenting profile information (step 400). For example, the gamer may browse the results of the search and view selected profile information. The gamer may then use his or her computing device (e.g., a computer, tablet device, or smart phone) to communicate with a selected gamer. Subsequent to the communication, the garners may interact socially and/or play games together by use of their computing devices (e.g., computing devices 14 shown in FIG. 1).

The method of FIG. 2 may include entering information about a match (step 600). For example, garners may interact with their respective computing devices to enter information about their match, which can be fed back into the gamer database 500 along with a users' behavior in searching, viewing profiles, and other behaviors within the web site 700.

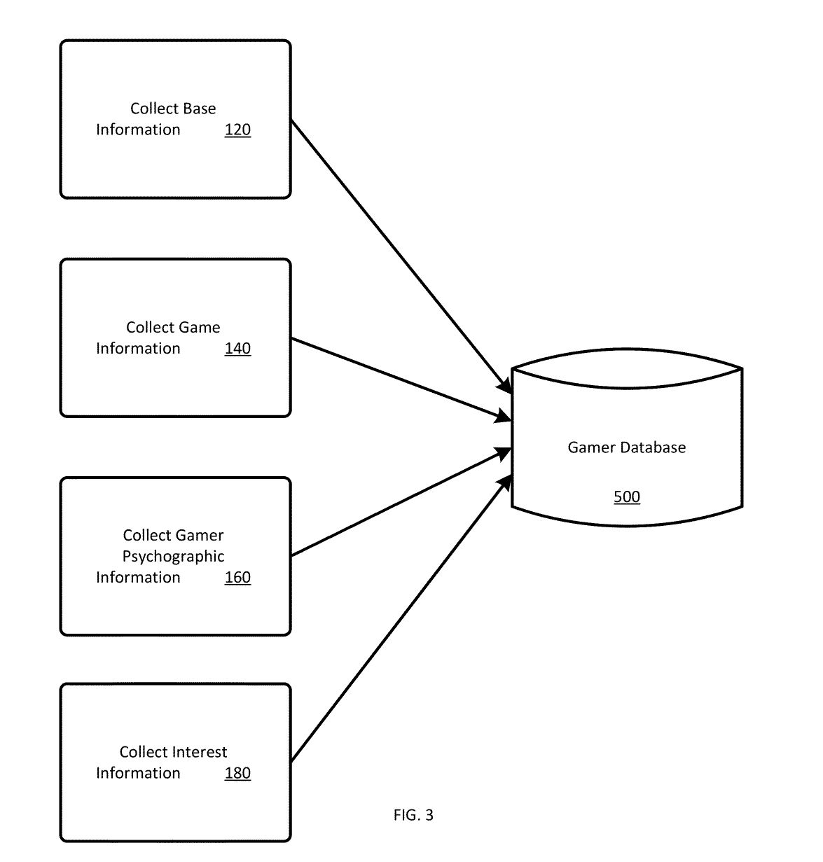

FIG. 3 illustrates a flow chart of an example method for collecting different types of information from garners in accordance with embodiments of the present disclosure. The method may be implemented, for example, by the module 18 of the web server 12 shown in FIG. 1 or on any suitable computing device. Referring to FIG. 3, a system or computing device may collect basic profile information of a gamer directly from a gamer's computing device or another computing device (step 120). This information may be stored in a gamer computer system database 500, such as memory accessible by the web server 12 shown in FIG. 1.

The method of FIG. 3 includes collecting game information (step 140). For example, subsequent to step 120, information about specific games may be collected from gamers' computing devices through direct entry or one or more other computing devices. Particular information may be collected about games that are of interest to other gamers.

The method of FIG. 3 includes collecting gamer psychographic information (step 160). For example, the gamer may interact with his or her computing device to answer a series of questions regarding their psychographics. Further, for example, the creation of questions that properly portray the attitude and style in which a particular gamer approaches games and other game specific factors may be presented to the gamer via his or her computing device. For example, information and/or graphics may be presented to a user via a display screen of the computing device.

The method of FIG. 3 includes collecting interest information (step 180). For example, the gamer provides may provide answers to questions about their psychographics across various games and gaming genres. Interests include, for example, but not limited to, items such as favorite music or movie genre. Particular questions and potential areas of interest may be presented to the gamer.

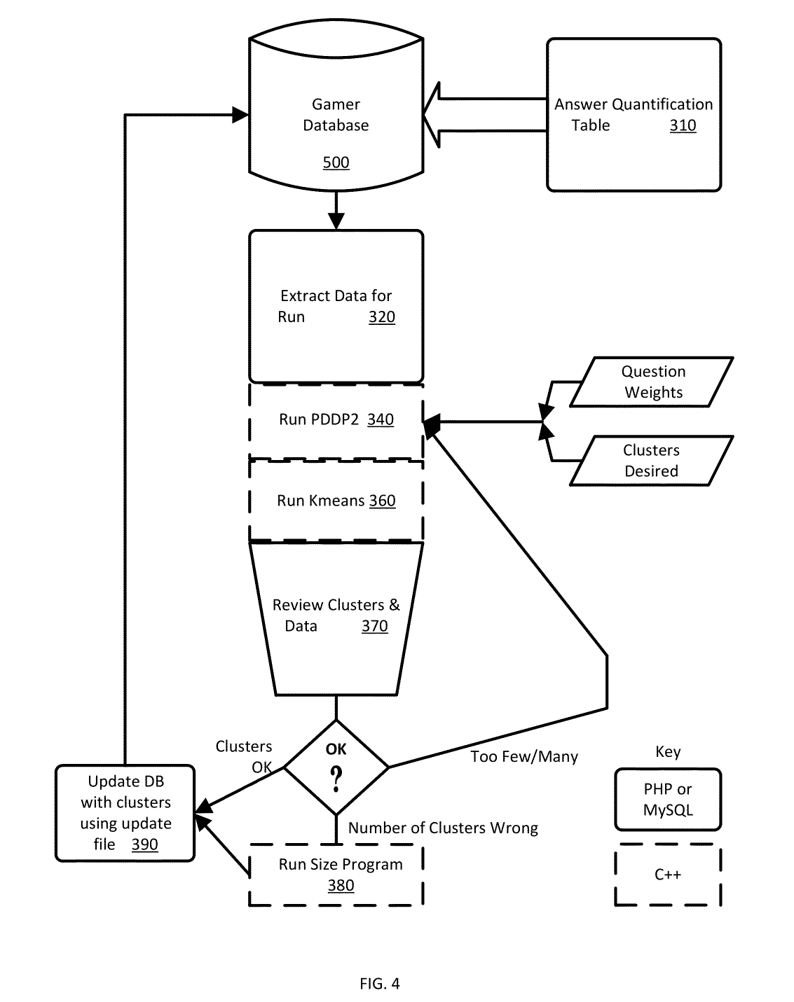

FIG. 4 illustrates a flow chart of an example method of appending additional information to a gamers profile using a mathematical program in accordance with embodiments of the present disclosure. The method may be implemented, for example, by the module 18 of the web server 12 shown in FIG. 1 or on any suitable computing device. In an example, a series of mathematical clustering techniques may be utilized along with techniques for interpreting and valuing information from the gamer and grouping the gamers. A computing device having one or more processors and memory may process the mathematical programs. Referred to herein as “clusters,” and also related cluster information, these new pieces of information may subsequently be appended to the computer systems gamer database 500.

Referring to FIG. 4, the method may include extracting data for run (step 320). For example, a computer program may implement processes in which data from a gamer's profile is processed for later use by the mathematical algorithm programs. A subset of information from the profile may be selected for subsequent processing by a computer program that may be written in PHP, for example. This method may be written in any suitable language as will be understood by those of skill in the art. The profile information provided by gamers may be quantified for use by other methods and programs. The quantification may be a view on the relative position of each answer. This quantification of each answer may be changed through experience. Each gamer may be represented as a vector with numerical entries. For example, a vector may have 15 numerical entries. This quantified profile may be stored in a computer file on a disk drive for later processing.

In accordance with embodiment of the present disclosure, a public domain mathematical algorithm known as two dimensional principal direction divisive partitioning, or PDDP2, may be used to select initial gamers whose data can be used as a starting point for later clustering computer programs (step 340). The algorithm was introduced by Daniel Boley in 1998 as a procedure that partitions an entire dataset into two clusters (D. L Boley, Principal direction divisive portioning, Data Mining and Knowledge Discovery, 2(4):325-344, 1998), the content of which is incorporated herein in its entirety. A computer program which incorporates the PDDP2 algorithm may be written in C++, although it may also be written in other suitable computer language. Techniques in accordance with embodiments of the present disclosure include computer files of parameter information that is processed by the PDDP2 algorithm along with the gamer data. One parameter file is question weights. Question weights are part of our method that identifies the relative importance of each question and answer for grouping gamers into clusters. For example, the time that a gamer prefers to play and their skill level may be very important. The PDDP2 computer program may subsequently use the two most important question/answer combinations (which are also coordinates in vectors) from this question weight file to select gamers who will first be processed by the clustering program. This can improve the efficiency of the clustering program.

A second computer parameter file may include information on the desired number of clusters. This information may be used by the computer system processing the PDDP2 mathematical algorithm to determine how gamers and their data can be selected and processed first by the k-means clustering program. The PDDP2 computer program may run on a computer processor and creates a file that is stored on disk media.

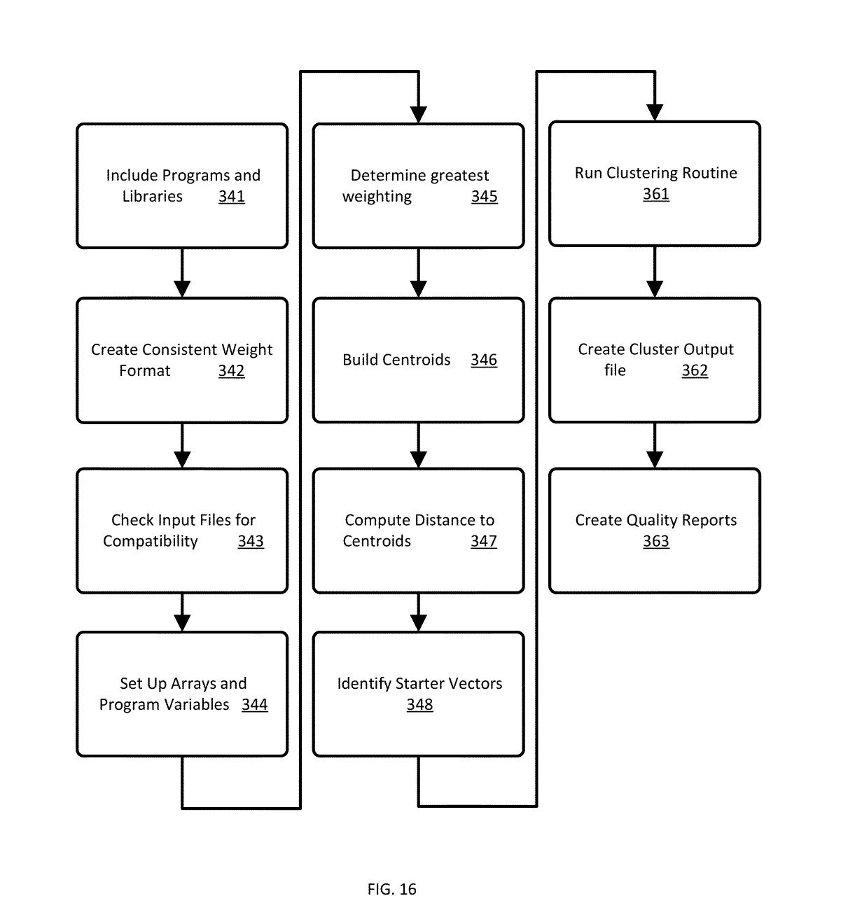

The method of FIG. 4 may include a computer program running on a computer processor to cluster gamers together into groups (step 360). This is further described with respect to the example of FIG. 16. Clustering techniques may be used to discover natural groups in datasets and to identify abstract structures that may reside there, without having any background knowledge of the characteristics of the data (J. Kogan, Introduction to Clustering Large and High-Dimensional Data, Cambridge University Press, New York, 2007), the content of which is incorporated herein in its entirety. In accordance with the present disclosure, this computer program may incorporate a public domain mathematical algorithm referred to as k-means. More specifically, in an embodiment, the clustering engine uses a combination of batch k-means and incremental k-means. Beyond the pioneering work of Steinhaus, the batch k-means builds on the work of Forgy (E. Forgy, Cluster analysis of multivariate data: Efficiency vs. interpretability of classification, Biometrics, 21(3):768, 1965) and MacQueen (J. MacQueen, Some methods for classification and analysis of multivariate observations. In Proceedings of the Firth Berkeley Symposium on Math, Stat. and Prob., pages 281-296, 1967), the content of which is incorporated herein in its entirety. Incremental k-means builds on the work of Duda, Hart and Stork (R. O. Duda, P. E. Hart, and D. G Stork. Pattern Classification. John Wiley & Sons, second edition, 2000), the content of which is incorporated herein in its entirety. The current computer program is written in the language of C++, but could alternatively be written in other suitable computer language. This program takes gamer profile information as vectors and computes a “representative” or centroid for each cluster. It then assigns gamers to each cluster based on distance from the centroids, seeking the nearest centroid given the number of desired clusters. The clustering engine may then use techniques of incremental k-means to change the cluster affiliation of a vector. Essentially the gamer vector whose reassignment to a new cluster leads to the best improvement in quality is selected and reassigned by the algorithm. The merger of batch and incremental k-means is used in this embodiment as suggested by Hansen et al, Kogan and Zhang et al (P. Hansen and Mladenovic N. J-Means: a new local search heuristic for minimum sum of squares clustering, Pattern Recognition, 34:405-413, 2001; J. Kogan, Means clustering for text data, In M. W. Berry, editor, Proceedings of the Workshop on Text Mining at the First SIAM International Conference on Data Mining, pages 47-54, 2001; G. Zhang, B. Kleyner and M. Hsu. A local search approach to k-clustering. Tech Report HPL-1999-119, 1999), the content of which is incorporated herein in its entirety. As output, each cluster may be uniquely identified in the computer system with a number. In embodiments of the present disclosure, the program processes the quantification of up to 15 question and answer combinations, however, it may be many more. The k-means approach to clustering may be suitably used in this example, however other clustering methods may be used in the alternative.

The clustering program, while processing on a computer processor, may take in the same computer files of parameters as the prior PDDP2 program. The clustering program may use the weights parameter file to interpret the relative importance of each question and answer combination. The number of clusters parameter file may be used to determine a target and maximum number of clusters to be developed by the clustering program. When processing on the computer, the K-means mathematical algorithm may produce fewer clusters than the desired number used as input to the program from the parameter file.

In accordance with embodiments, information that should be recorded on computer files may be specified as an output of the clustering program. The output may include a file of each gamer and their assigned cluster number. In addition, the example method includes reporting that analyzes the quality of the clusters developed. This reporting includes efficiency information such as the number of iterations and quality information such as the density of each cluster and the sum of the densities of all the clusters.

The method of FIG. 4 includes manually reviewing the output of the clustering program (step 370). In an example, a system administrator may review the output of the clustering program against a set of criteria. These include, but are not limited to, reviewing the density of the clusters, reviewing individual gamer information within sample clusters, and reviewing the number of gamers in each cluster. Based on the manual review and analysis of the output of clustering program, the clustering engine and associated programs may be rerun with changes to the parameter files. Subsequently, the review process is repeated until the system administrator is satisfied.

As part of the example method of FIG. 4, the method may include resizing the number of gamers within the cluster (step 380). For example, the system administrator may choose to run output files from the clustering program through another program that resizes the number of gamers within a cluster. The k-means clustering algorithm may produce clusters with any number of gamers greater than 1. For the gamer selection technique, clusters may be expected to have a sufficient number of gamers. At the same time, the clusters of gamers may not be too large as it can affect the searching for gamers. A software program referred to as SIZE may be run on the computer processor by the administrator to create minimum and maximum size clusters of gamers. The current SIZE program is written in the programming language C++, although it may be written in any other suitable language.

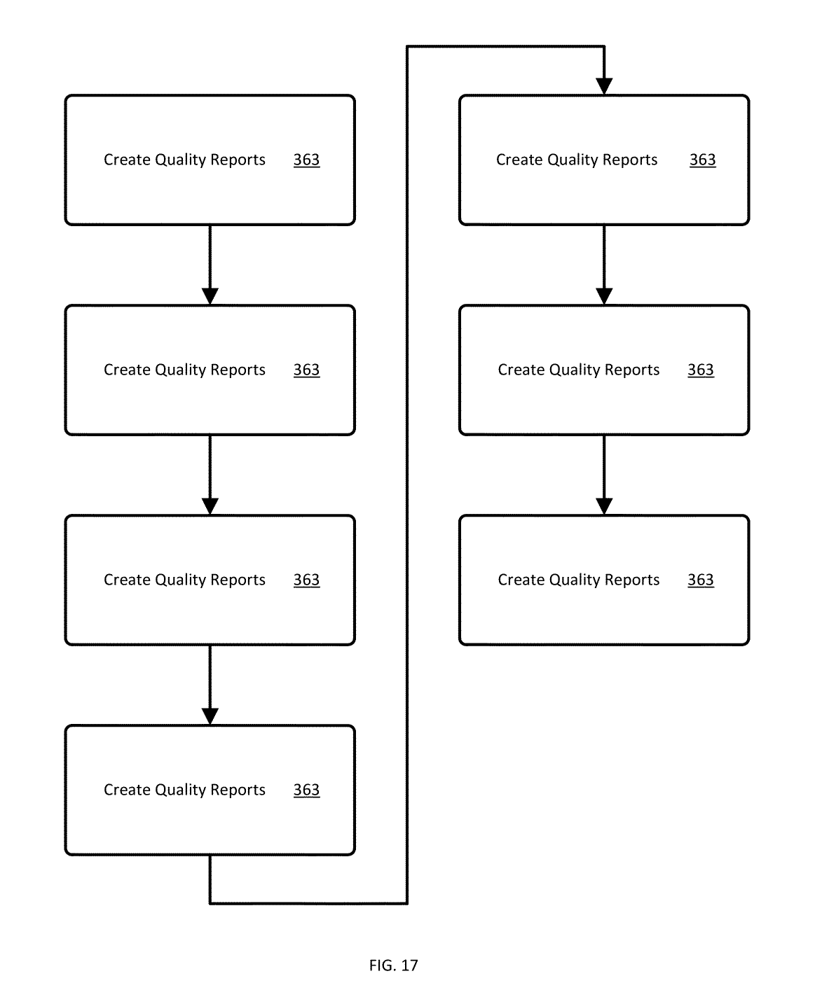

The SIZE computer program, described as part of the method in FIG. 17, may in a computer file that is the output of the clustering computer program along with parameters of desired minimum and maximum number of gamers within a cluster. The minimum and maximum numbers of gamers for a cluster are entered by an administrator. The SIZE program first validates the input parameters of minimums and maximums. It may identify clusters as “donors” or “recipients.” The program moves gamers from donor clusters to recipient clusters with the minimum reduction in quality. This continues until the maximum and minimum cluster sizes are met. The output of the SIZE computer program is a computer file with gamer identifiers and revised cluster numbers. There is also an output of a computer file or report which is used by the system administrator to confirm the appropriateness of the computer processing of the SIZE program.

The method of FIG. 4 includes updating the database with clusters using an update file (step 390). For example, a computer program may process the computer file output of the clustering program or the SIZE program. This computer program may take the cluster information for each gamer and updates the gamer database 500. This update program may be suitably implemented in the PHP computer language. Alternatively, it may be coded in any other language.

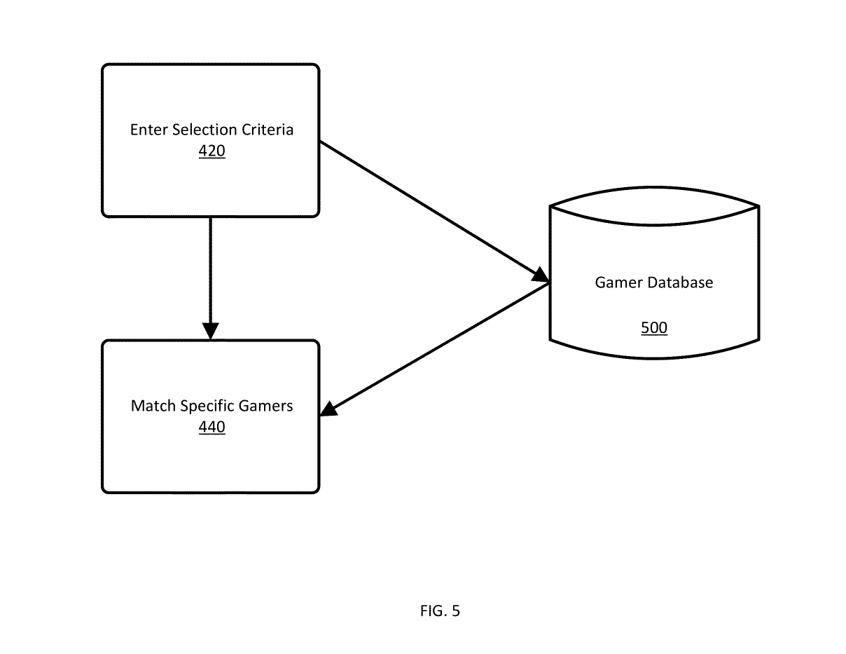

FIG. 5 illustrates a flow chart of an example method of the gamer selection feature incorporating searching for gamers and matching gamers in accordance with embodiments of the present subject matter. The method may be implemented, for example, by the module 18 of the web server 12 shown in FIG. 1 or on any suitable computing device. Referring to FIG. 5, the method may include entering selection criteria (step 420). For example, a gamer may enter selection criteria to search for another gamer 420. The example method may provide an ability to select from a wide variety of attributes on a gamer's profile to find a gamer. This may provide a gamer with an ability to find an exact match or the attributes in other gamers' profiles. This type of search may be referred to as a direct search. Further, the method of FIG. 5 may include matching specific gamers (step 440). For example, computer programming code may be configured to take the search criteria and attempt to match it to other gamers within the gamer database 500. For example, the program for entering selection criteria is coded in PHP and HTML. The matching program is coded in PHP and MySQL. Any other suitable language may be used.

The example method may also include providing a feature for allowing a user to add search criteria through the computer system that the searching gamer is not aware of. An example purpose of this is to not only meet the direct search criteria entered by the gamer, but to improve the search by adding criteria which increases the similarity of the gamer searching and the gamers found. For example, cluster or preferred playing language may be appended to the direct search by the system in the background. This may cause the search results to include gamers who share personality traits, interests and other attributes with the searching gamer. Other criteria may be added to the direct search criteria of the gamer such as language and preferred playing time.

In addition, an example method may include inexact matches. These are matches that are close to exact matches, but not exactly the same. The computer system administrators have the ability to set tolerances around search criteria. When a match is not exact but within tolerances, it will be reported as less than 100% match. Mathematically derived, a scale is used to determine match percentages. This information is contained in a computer file or database and used by the search program.

In accordance with an embodiment, an example method may also contain a process for a gamer to have the computer select a good match for them. Most typically, the gamer can provide a game they are interested in playing as search criteria and the techniques disclosed herein may find a peer for them automatically. The search can look for similar gamers within the searching gamer's cluster. Further, a search can return gamers who are similar as well as information on a match percentage. When a match is not exact, it will be reported as less than 100% match. Mathematically derived, a scale may be used to determine match percentages for searches disclosed herein.

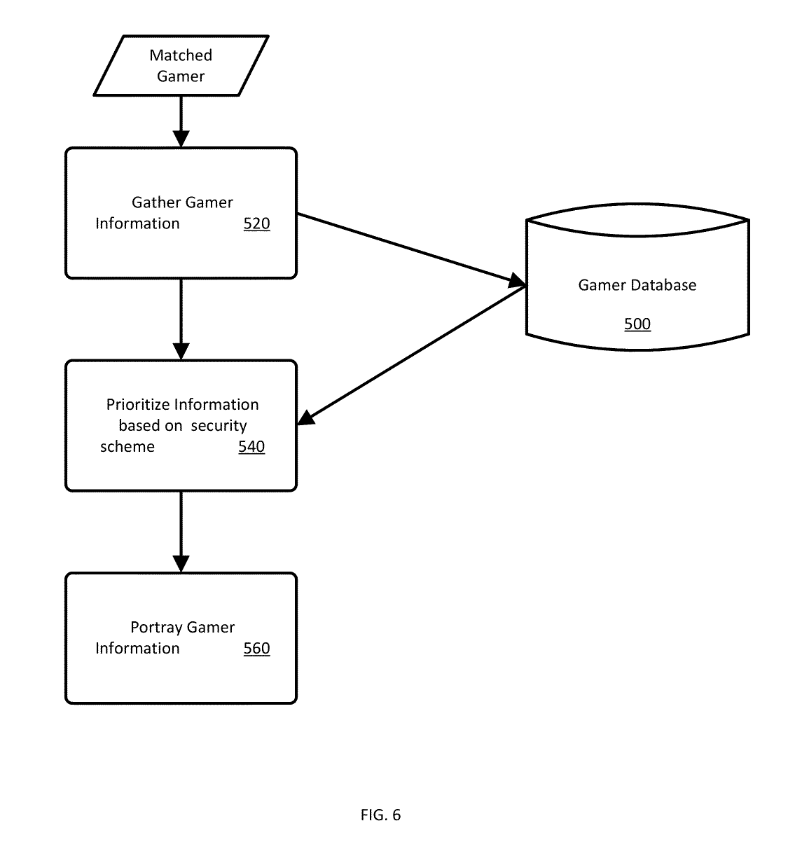

FIG. 6 illustrates a flow chart of an example method of the gamer selection feature portraying search results in accordance with embodiments of the present subject matter. The method may be implemented, for example, by the module 18 of the web server 12 shown in FIG. 1 or on any suitable computing device. Following the computer matching of search criteria to gamers, the method includes gathering information to be portrayed or presented to the searching gamer (step 520). This information is stored in computer memory in by a computer program. In the present disclosure, this computer program is written in PHP and MySQL, although it may be implemented in any suitable programming language. Information may be gathered from both the searching gamer and the search result gamer for portrayal or presentation.

The method of FIG. 6 includes prioritizing information based on a security scheme (step 540). For example, information may be prioritized and presented based on a privacy and security scheme. Information in a profile may be categorized according to the privacy and security scheme. Some information may not be portrayed to any other user and may be permanently set as “private information.” Another set of information may be considered “public information” and may be available for all users to see based on searches. Other information may be portrayed or visible based on a designation of one gamer by another gamer. For example, a gamer may designate another gamer as a peer, in which case additional information may be visible.

The method of FIG. 6 includes portraying or presenting gamer information (step 560). For example, a variety of search result portrayals may be provided within the guidelines of the privacy and security scheme discussed herein above. Information from the gamer database 500 can e translated into easy to understand statements that describe the search result gamer. More than one gamer may be displayed.

In accordance with embodiments, an example method may include the ability to portray comparative information between the gamer who executed the search and the search result gamer(s). This comparative information may be portrayed directly on a computer screen. Alternatively, the example method in the computer program may compare the two gamers' information and present a conclusion to the searching gamer. For example, the computer program may present on a computer screen “You both like alternative music.”

In accordance with embodiments of the present disclosure, the gamer grouping and matching technique operates in a computer system. Profiles can be entered on computer devices, tablet devices, mobile phones, and like devices. Profile information may also be collected from other computer systems. Gamers may use the systems and methods disclosure herein from any computer, tablet device, or mobile phone capable of running an Internet browser.

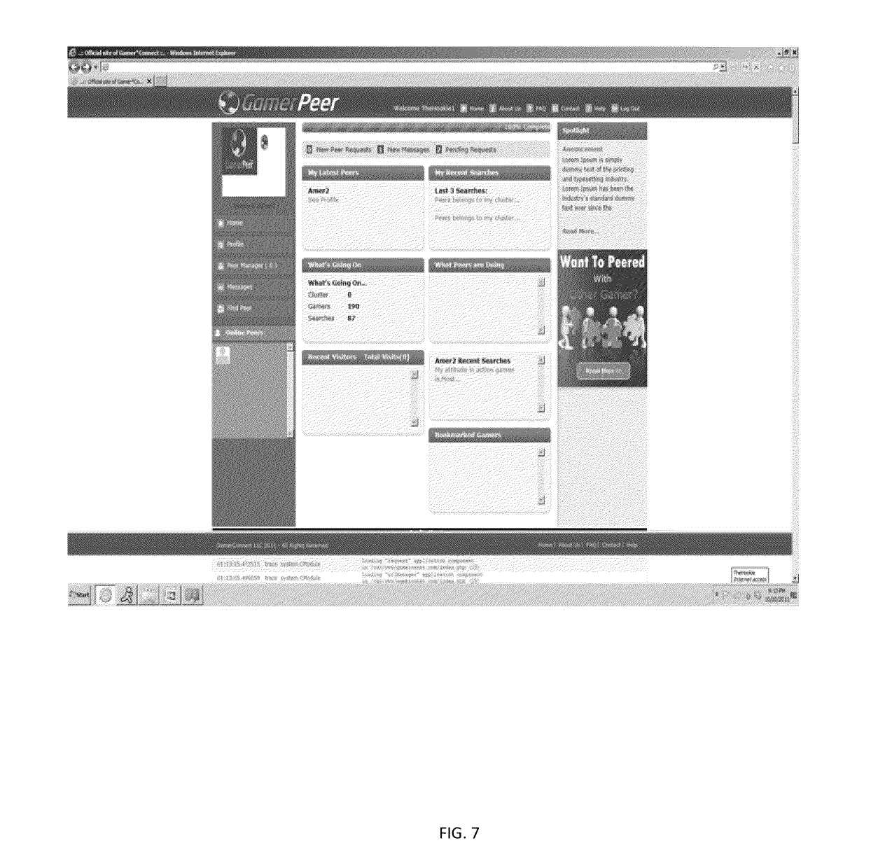

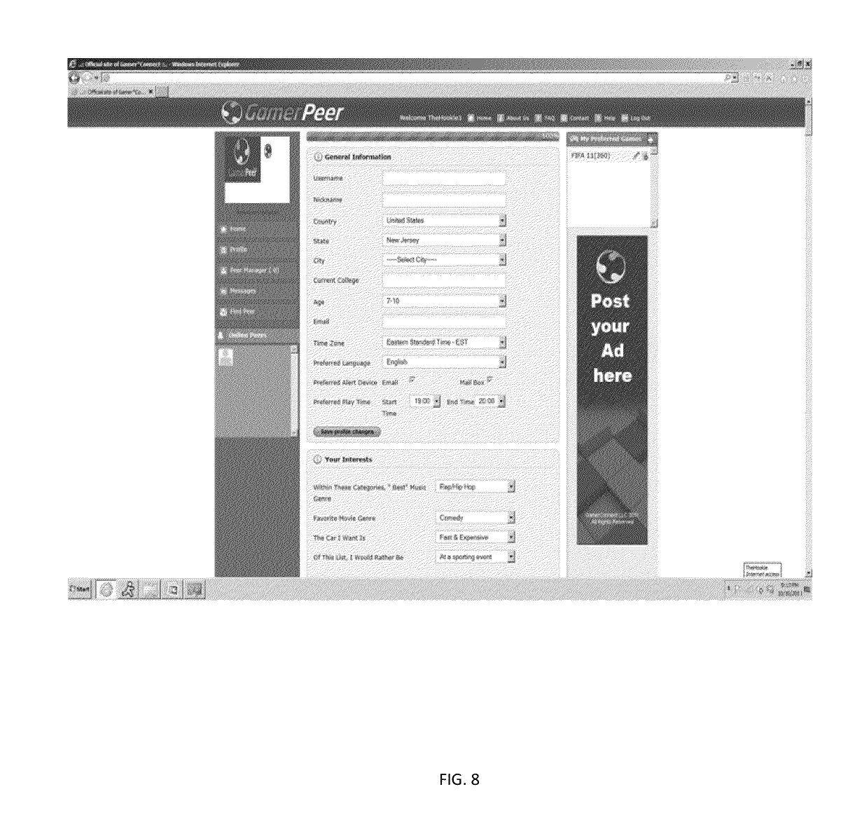

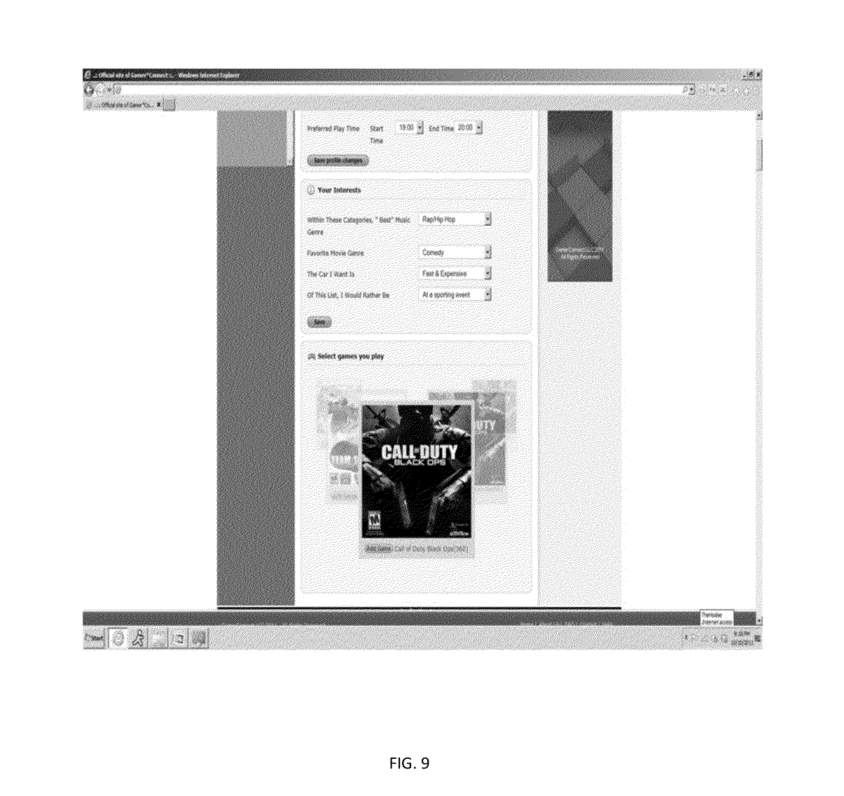

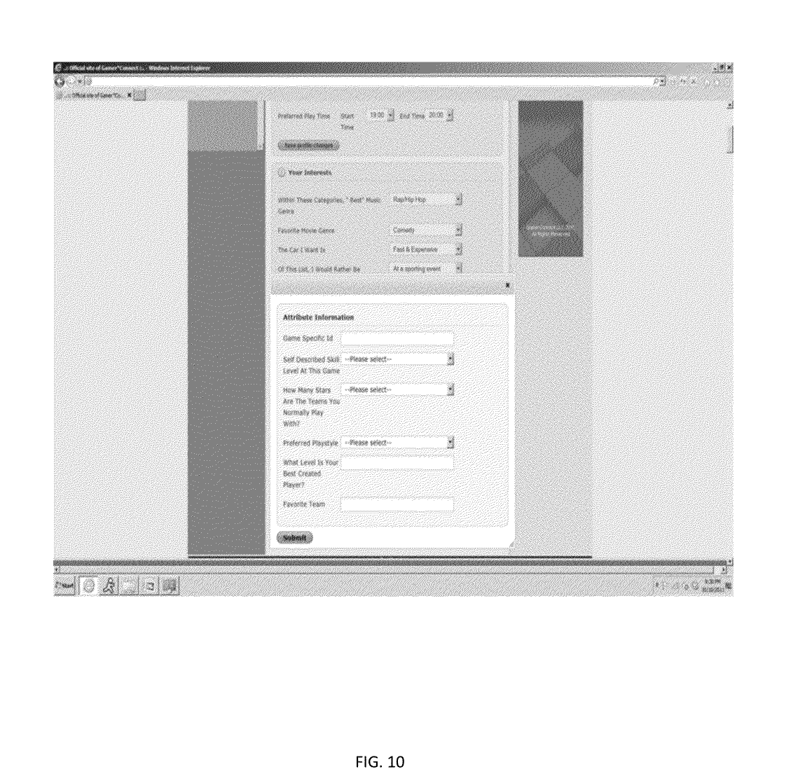

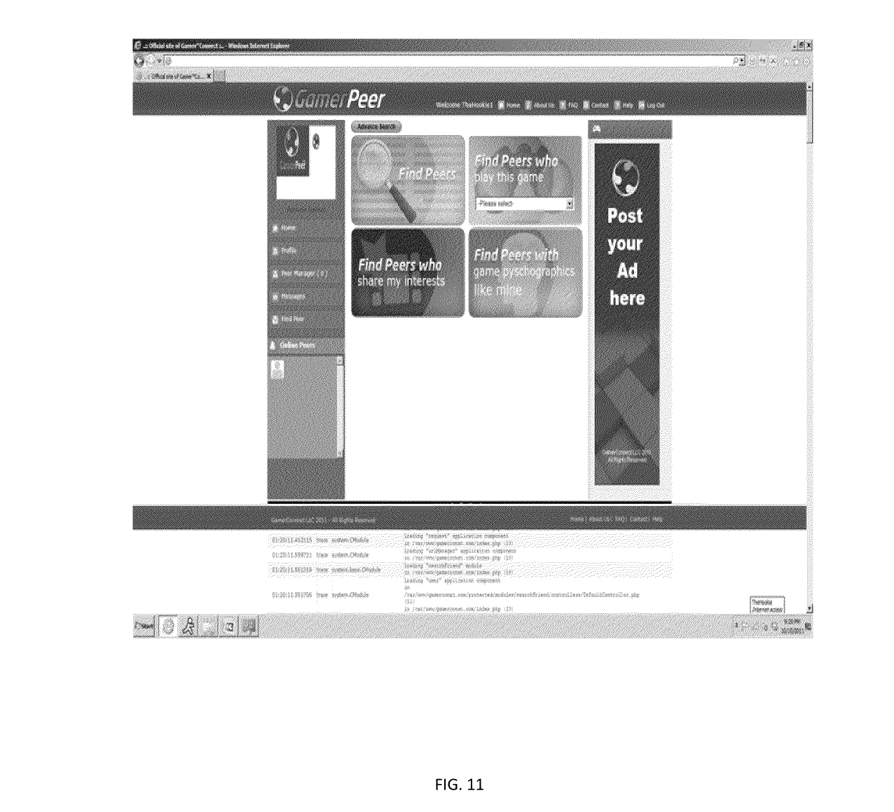

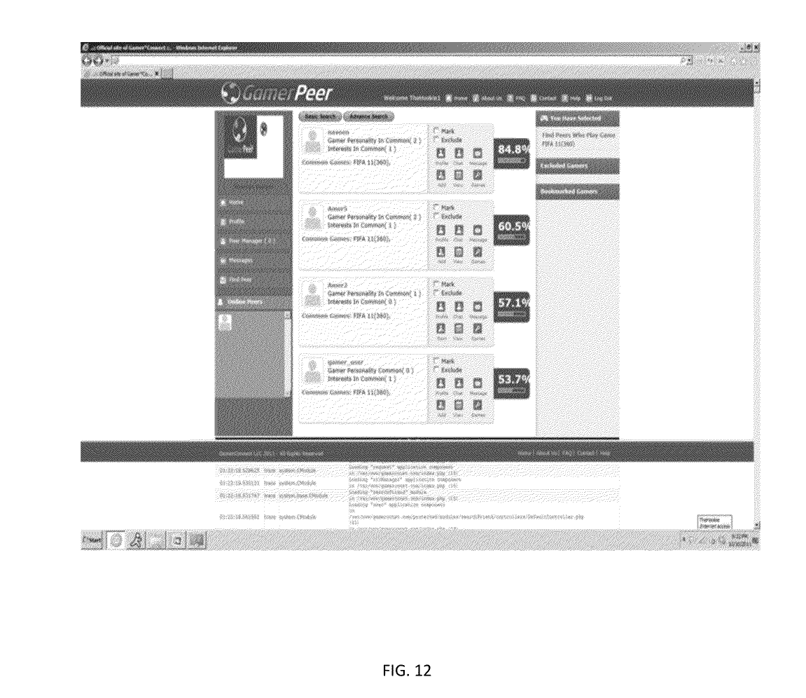

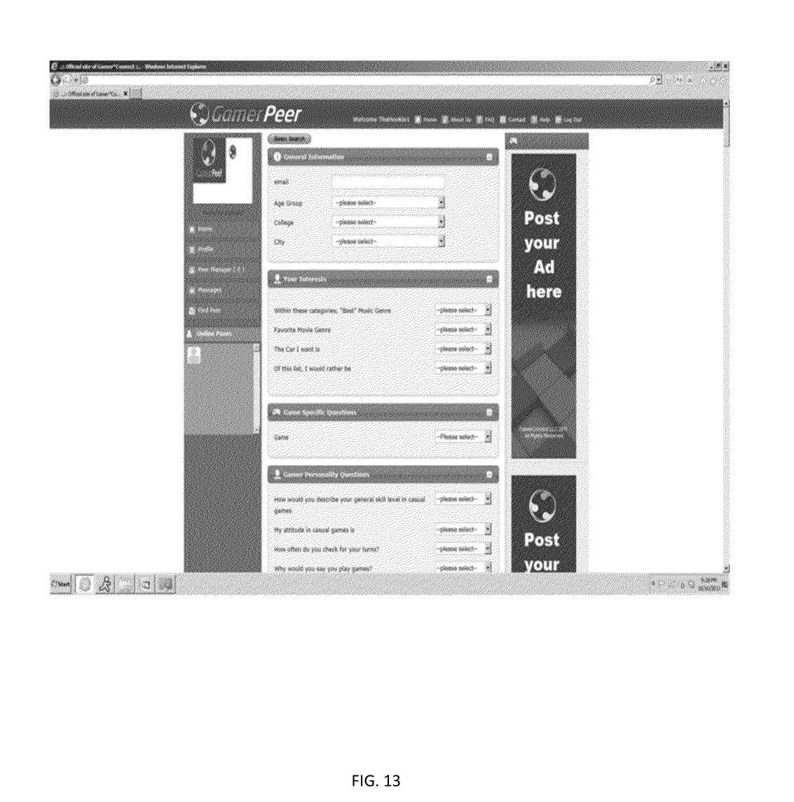

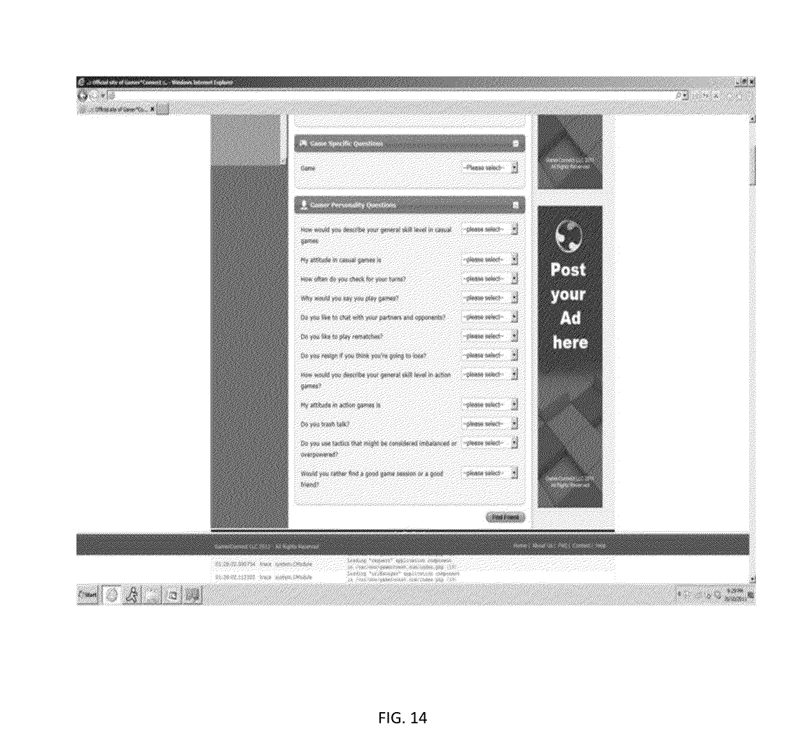

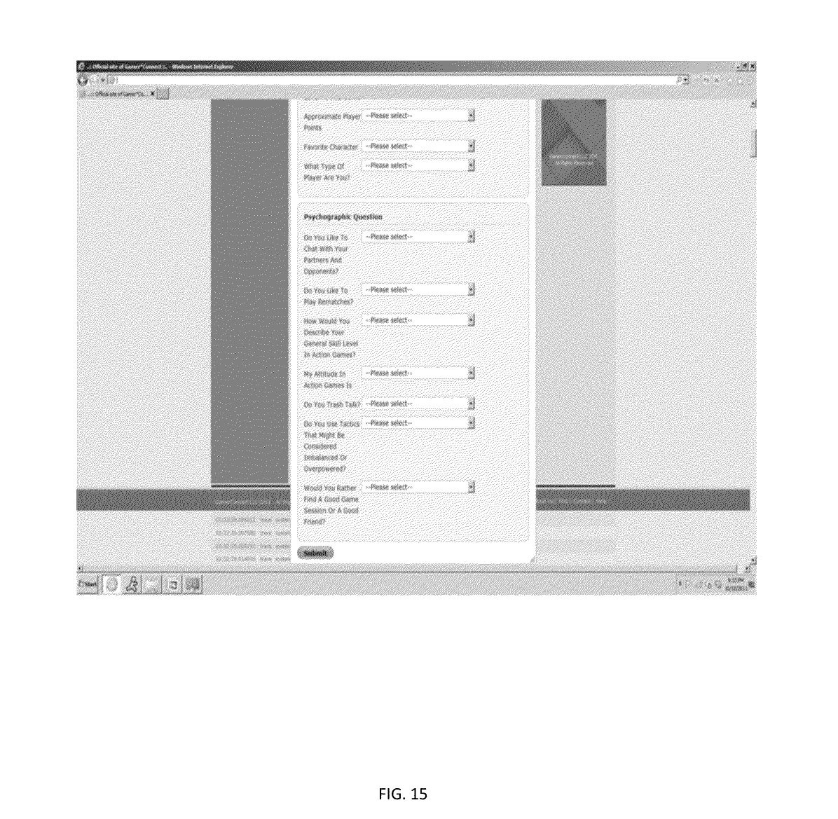

FIGS. 7-15 depict various example screen shots presented to a gamer in accordance with embodiments of the present disclosure. Referring to FIG. 7, the screen shot is a website homepage depicting various user interface components for interaction by the gamer. FIG. 8 depicts a screen shot of a webpage with which a gamer may interact for entering his or her profile information. FIG. 9 depicts a screen shot of a webpage with which a gamer may interact for entering additional profile information. FIG. 10 depicts a screen shot of a webpage with which a gamer may interact for entering his or her answers to various questions. FIG. 11 depicts a screen shot of a webpage with which a gamer may interact for searching for another gamer. FIG. 12 depicts a screen shot of a webpage with which a gamer may interact for searching for another gamer from a game. FIGS. 13 and 14 depict screen shots of webpages with which a gamer may interact for conducting an advance search for another gamer. FIG. 15 depicts a screen shot of a webpage with which a gamer may interact for specifying action psychographic information.

FIG. 16 illustrates a flow chart of an example method of PDDP k-means program flow in accordance with embodiments of the present disclosure. The method may be implemented by the module 18 of the web server 12 shown in FIG. 1. Referring to FIG. 16, the method involves including programs and libraries (step 341). The method also includes creating a consistent weight format (step 342). Further, the method includes checking input files for compatibility (step 343). The method also includes setting up arrays and program variables (step 344). Further, the method includes determining a greatest weighting (step 345). The method also includes building centroids (step 346). Further, the method includes computing distance to centroids (step 347). The method also includes identifying starter vectors (step 348). The method further includes running a clustering routine (step 349). The method also includes creating a cluster output file (step 350). Further, the method includes creating quality reports (step 363).

FIG. 17 illustrates a flow chart of an example method of size program flow in accordance with embodiments of the present disclosure. The method may be implemented by the module 18 of the web server 12 shown in FIG. 1. Referring to FIG. 17, the method includes inputting data and initial partitions (step 381). Further, the method includes inputting minimum and maximum cluster sizes (step 382). The method also includes identifying donor (D) and recipient (R) clusters (step 383). Further, the method includes removing gamers from donor and recipient clusters (step 384). The method also includes continuing until no donors remain (step 385). The method also includes reporting the final partitions (step 386). Further, the method includes creating quality reports (step 387).

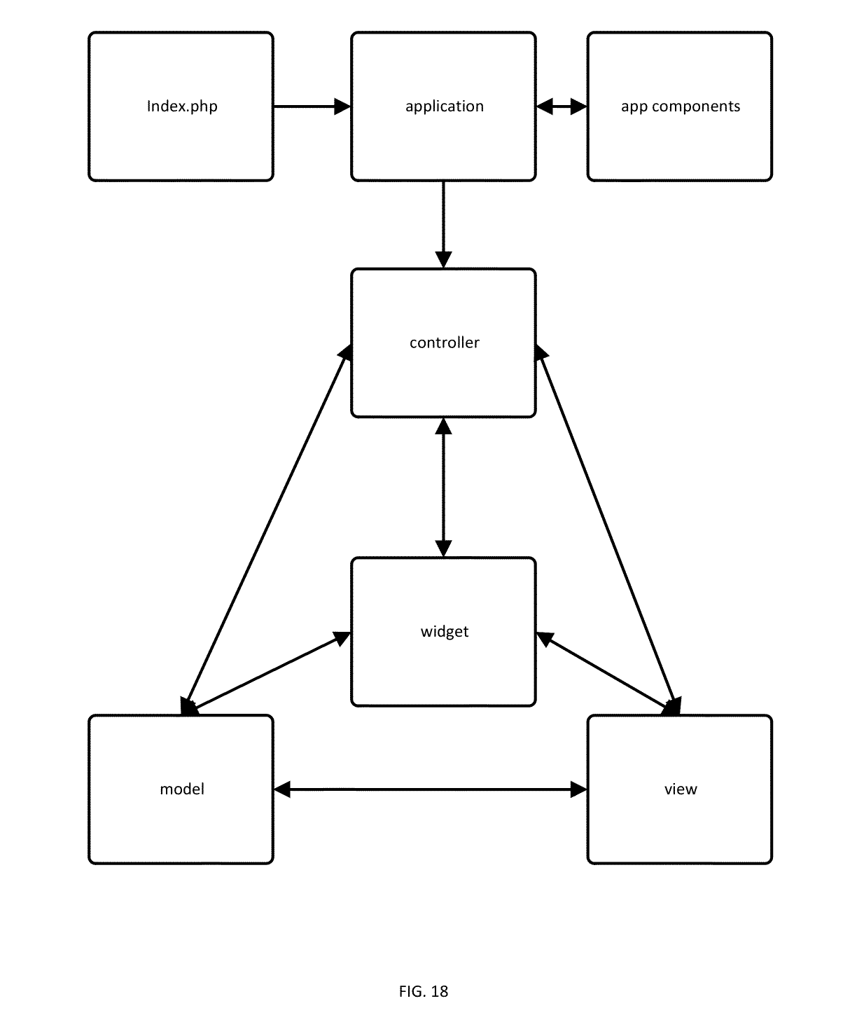

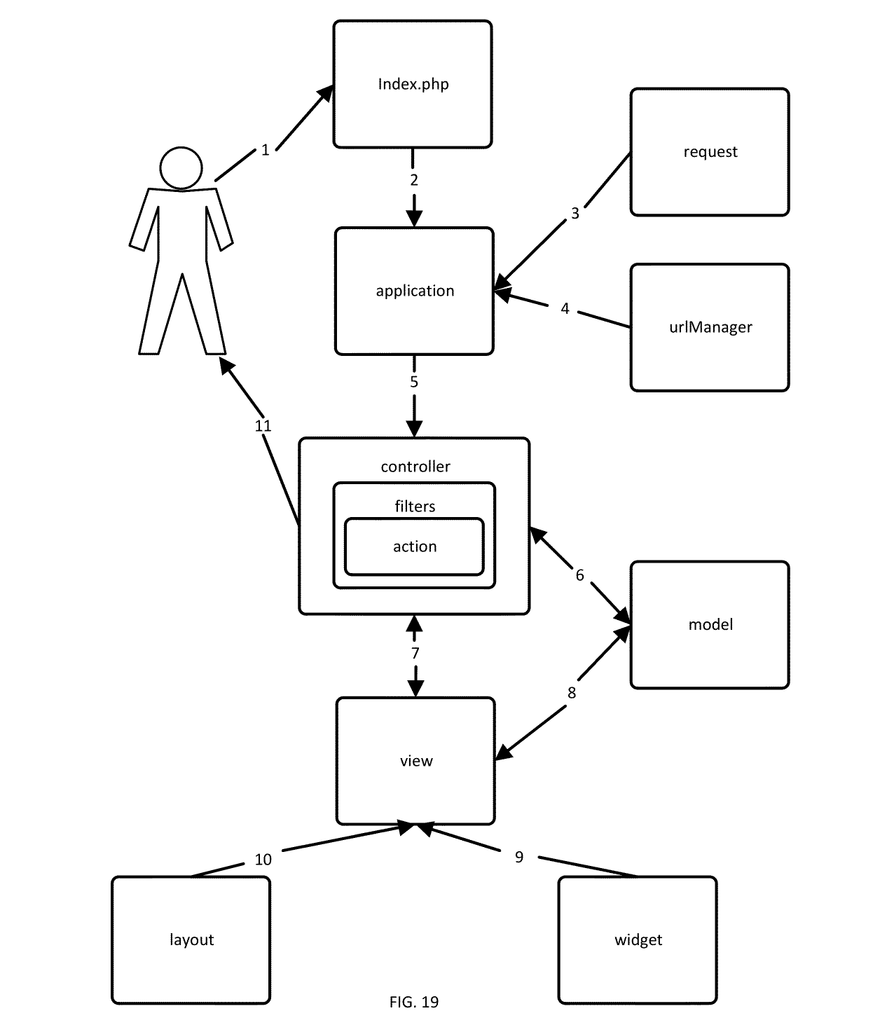

FIGS. 18 and 19 depict an example overall architecture of software programs implemented on a computing device in accordance with embodiments of the present disclosure. In general, this example architecture is written in the PHP programming language using what is referred to as the Yii architectures. The software programs that embody the gamer grouping and matching techniques, and the associated files, databases and processors may operate or a computer, server, or in the “cloud.” The cloud is a term which described computer services available through Internet connection rather than necessarily physically in the presence of the operator. Administrators may interact with the gamer grouping and matching features by adjusting parameters over time based on experience.

From the description above, a number of advantages of our gamer grouping and matching techniques become apparent. For example, gamers can find appropriate opponents and teammates for the games that they play based on gaming psychographics and game-specific information such as:
a. General skill level and skill levels as defined by the games themselves;
b. The gamer's playing mood, such as the desire to practice, play casually, or play competitively;
c. The times of day the gamers prefer to play;
d. The gamers location, including their college or city;
e. Gaming style with which they play games;
f. Interests, i.e.—personal interests they may share in common with other gamers; and
g. Other information as collected on the profile, which can include in site behavior, external data collection, and other information about gamers.

Further, for example, gamers can find or interact with other players without revealing their true identity.

In another example, gamers can get to know each other at over time revealing information about themselves in stages.

In another example, gamers may become friends with each other based on shared interests.

In another example, gamers may conveniently interact with the system and each other on different types of devices that access the Internet.

In another example, gamers may learn more about other gamers and the gaming community.

In another example, gamers can find other games that their gaming partners play.

In another example, gamers can avoid inappropriate gaming partners provided the games themselves.

In another example, gamers are provided greater freedom to plan their gaming sessions ahead of time by searching for their appropriate match before hand

In another example, gamers are given greater freedom to search and communicate with matches across multiple games and platforms.

In another example, gamers are more likely to have a better gaming experience when playing with appropriate players.

In another example, gamers are able to search for matches outside of the environment of any particular game or platform, which often are operated by cumbersome and unintuitive controllers and interfaces.

It should be understood that a gamer may find another gamer to play games with and get to know conveniently and in a unique way. The gamer can find opponents and teammates through searching the database themselves. The gamer can also allow the method to select gamers for them. Being matched based on psychographic and game specific information about other gamers helps ensure they are compatible to have a positive experience playing together.

People play games for myriad reasons. To many, gaming is a primarily social experience; to others it may be competitive or diversionary. Beyond their reasons, gamers have diverse skill levels, available playing times, personal interests, and other variables that influence who is an appropriate gaming match for them. Existing computer game matchmakers often ignore these complexities and offer only an often obtuse and unresponsive experience that is at times vexing and annoying or even pointless at worst. The disclosed systems and methods provides a revolution in how gamer matchmaking is operated, one that allows it to catch up to the sophistication of social networks today. This system allows gamers to choose their matches with an unprecedented level of ease, accuracy, and control. They can play with who they want, when they want, how they want, and they can do these things from within an intuitive interface that allows for operation on their own schedule and terms.

It is noted that many of the example search techniques disclosed herein are described as searching for gamers within a group; however, the techniques of searching in accordance with the present subject matter should not be considered so limiting. For example, a search for other garners may also include searching among garners that are not a part of a group or cluster. Further, for example, a search may include searching among a combination of grouped garners and ungrouped garners.

Although the description above contains many specificities, these should not be construed as limiting the scope of the embodiments but merely providing illustrations of embodiments. For example, the gamer grouping and matching features may run as an independent system as described above, but may also be invoked from within another software program through a single button or may be invoked from within a computer-based game. Also, the example systems and methods disclosed herein can be embodied in a more limited form with less searching and matching capability, such as on a mobile device like a phone. The example systems and methods disclosed herein can also be embodied with a much larger amount of profile information, with input similar to a profile but not referred to as a “profile.” Input to the selection and matching embodiments can be generated by a human or a computer. Different parameters with different values may be used by the systems and methods disclosed herein. Thus, the scope of the embodiments should be determined by the appended claims and their legal equivalents rather than by the examples given.

The various techniques described herein may be implemented with hardware or software or, where appropriate, with a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed invention. In the case of program code execution on programmable computers, the computer will generally include a processor, a storage medium readable by the processor (including volatile and non-volatile memory and/or storage elements), at least one input device and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed invention. When implemented on a general-purpose processor, the program code combines with the processor to provide a unique apparatus that operates to perform the processing of the presently disclosed invention.

Features from one embodiment or aspect may be combined with features from any other embodiment or aspect in any appropriate combination. For example, any individual or collective features of method aspects or embodiments may be applied to apparatus, system, product, or component aspects of embodiments and vice versa.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method for grouping gamers, the method comprising:
using at least a processor and memory for:
receiving data associated with a plurality of gamers;
analyzing the data to assign each of the gamers to one of multiple gamer groups; and
providing a search tool to at least one gamer for searching for other gamers based on the assigned groups.

2. The method of claim 1, wherein receiving data comprises receiving the data via a network.

3. The method of claim 2, wherein receiving data via a network comprises receiving the data via the Internet.

4. The method of claim 1, wherein receiving data comprises receiving psychographic information associated with the plurality of gamers.

5. The method of claim 1, wherein analyzing the data comprises applying a mathematical algorithm to the data for assigning each of the gamers to one of the gamer groups.

6. The method of claim 5, wherein applying a mathematical algorithm comprises clustering each gamer into one of the gamer groups.

7. The method of claim 6, further comprising using the search tool for a user to search within one or more of the gamer groups.

8. The method of claim 1, wherein providing a search tool comprises defining search criteria based on one or more of general information, action gaming psychographics, casual gaming psychographics, and game specific information.

9. The method of claim 1, further comprising using the search tool to identify one or more gamers based on a search criteria specified by the at least one gamer.

10. The method of claim 9, further comprising enabling communication between the at least one gamer and the identified one or more gamers.

11. The method of claim 10, further comprising managing interaction with and information associated with the identified one or more gamers.

12. A system for grouping gamers, the system comprising:
at least a processor and memory configured to:
receive data associated with a plurality of gamers;
analyze the data to assign each of the gamers to one of multiple gamer groups; and
provide a search tool to at least one gamer for searching for other gamers based on the assigned groups.

13. The system of claim 12, wherein the at least a processor and memory is configured to receive the data via a network.

14. The system of claim 13, wherein the at least a processor and memory is configured to receive the data via the Internet.

15. The system of claim 12, wherein the at least a processor and memory is configured to receive psychographic information associated with the plurality of gamers.

16. The system of claim 12, wherein the at least a processor and memory is configured to apply a mathematical algorithm to the data for assigning each of the gamers to one of the gamer groups.

17. The system of claim 16, wherein the at least a processor and memory is configured to cluster each gamer into one of the gamer groups.

18. The system of claim 17, wherein the at least a processor and memory is configured to use the search tool for a user to search within one of the gamer groups.

19. The system of claim 12, wherein the at least a processor and memory is configured to define search criteria based on one or more of general information, action gaming psychographics, casual gaming psychographics, and game specific information.

20. The system of claim 12, wherein the at least a processor and memory is configured to use the search tool to identify one or more gamers based on a search criteria specified by the at least one gamer.

21. The system of claim 20, wherein the at least a processor and memory is configured to enable communication between the at least one gamer and the identified one or more gamers.

22. A method for allowing gamers to search for and find each other, the method comprising:
using at least a processor and memory for:
collecting information about a gamer;
organizing the information by use of a mathematical algorithm for grouping users;
providing a search tool to search for other gamers based on the organization information; and
presenting, to each gamer, information associated with other gamers.

23. The method of claim 22, wherein collecting information comprises collecting information across a plurality of games played by a gamer,
wherein organizing the information comprises using a computing device to organize the information for search, and
wherein the method further comprises storing the organized information in a database.

24. The method of claim 22, wherein collecting information comprises collecting psychographic information for a user,
wherein organizing the information comprises searching by use of a computing device, and
wherein the method further comprises storing the organized information in a database.

25. The method of claim 22, further comprising organizing the information into sections for searching based on one or more of general information, action gaming psychographics, casual gaming psychographics, and game specific information.

26. The method of claim 22, further comprising using information about gamers to generate groups of gamers who share similarities for use in searching gamers.

27. The method of claim 26, further comprising quantifying information about a gamer is quantified for use in mathematical algorithms.

28. The method of claim 26, wherein an output of the mathematical algorithm is configured to be adjusted by system administrators for the purpose of predefined group sizing.

29. The method of claim 22, further comprising providing a search tool for use by searching gamers to one of search within their groups and search surrounding clusters.

30. The method of claim 29, wherein providing the search tool comprises receiving user input for a user to add additional search parameters.

31. The method of claim 29, wherein providing the search tool comprises allowing a user to search based on information including one of college attended, psychographic information, and game specific information.

32. The method of claim 22, further comprising providing, to gamers, a percentage match based on an overlap of information including information used for determining clusters.

33. The method of claim 20, further comprising presenting, to a gamer, a profile of relevant information to determine whether the gamer is interested in peering with a found gamer for one of gaming and social reasons.

34. The method of claim 33, further comprising managing interaction with and information associated with one or more peered gamers.

35. The method of claim 34, wherein presenting to each gamer comprises presenting, to each gamer, information that is different based on the relationship of the gamers, including at least public information, peer information, and private information.

36. A system for grouping gamers and allowing the grouping gamers to search for and find each other online, the system comprising:
at least a processor and memory configured to:
collect information about a gamer of interest to other gamers;
quantify the information into vectors of information;
implement mathematical algorithms to group gamers into appropriate groups;
provide search tools to search the information to find matching one of gaming partners and social contacts;
present matching gamer information to one or more gamers; and
provide an interface for gamers to peer for one of social and game playing purposes.

37. The system of claim 36, wherein the at least a processor and memory are configured to collect information via one or more computing devices about a gamer in a database that is of interest to other gamers for gaming and social purposes.

38. The system of claim 37, wherein the information includes city, college, age group, psychographic information, game skill information, attitude information, gaming likes, and gaming dislikes.

39. The system of claim 36, wherein the at least a processor and memory is configured to provide system administrators with a set of heuristics and tools to quantify information about gamer users into integers on vectors for use in mathematical algorithms to identify similarities among individual and groups of gamers.

40. The system of claim 36, wherein the at least a processor and memory is configured to implement mathematical algorithms for identifying similarities and differences among gamers and for grouping in a cluster gamers.

41. The system of claim 40, wherein a size of the cluster is adjusted via an interface.

42. The system of claim 36, wherein at least a processor and memory is configured to provide tools configured to search for other gamers, wherein the tools provide computer assisted searches for gamers within a cluster.

43. The system of claim 36, wherein the at least a processor and memory is configured to present, to a gamer, the information of other gamers for determining whether to peer with that gamer for the purpose of one of gaming and social networking.

44. The system of claim 36, wherein the at least a processor and memory is configured to provide a search tool to allow gamers to communicate with other gamers for the purpose of one of gaming and social networking, wherein a communication includes an invitation to peer with other gamers.

45. The system of claim 36, wherein the at least a processor and memory is configured to provide a gamer with a tool to manage and to group other gamers with whom they have peered for the purpose of reviewing information, access and communication, wherein the tool provides the gamer with an interface to record information about the other gamers.

46. The system of claim 36, wherein the at least a processor and memory is configured to provide a privacy scheme for revealing information based on different levels of relationship between gamers, wherein the information includes information that is available publicly to other gamers, information that is available only to peered gamers, and information that is always kept private.
